(19) United States
(12) Patent Application Publication
(10) Pub. No.: US 2020/0384553 A1
(43) Pub. Date: Dec. 10, 2020

(54) ROTARY CUTTING UNIT FOR A ROTARY SAW

(71) Applicants: Chin-Fa KAO, Lukang Township (TW); Yao-Hsien HSU, Lukang Township (TW); Huang-Ming HSU, Lukang Township (TW)

(72) Inventors: Chin-Fa KAO, Lukang Township (TW); Yao-Hsien HSU, Lukang Township (TW); Huang-Ming HSU, Lukang Township (TW)

(21) Appl. No.: 16/783,828

(22) Filed: Feb. 6, 2020

(30) Foreign Application Priority Data
Jun. 4, 2019 (TW) 108119313

(51) Int. Cl. B23B 51/04

(52) U.S. Cl. CPC B23B 51/048

(57) ABSTRACT

A rotary cutting unit for a rotary saw has a cross bar and at least one cutting structure, wherein the cutting structure is in contact with the cross bar. The cross bar runs through sleeve holes. The center of gravity of the turning unit is located in an axis of the center of the sleeve holes. The axis is perpendicular to the transverse axis of the crossbar. The rotary saw selectively installs the rotary cutting unit of the corresponding specification, and it can quickly and easily change the aperture of the circular hole to be processed, and with high usability.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

### 1. Field of the Invention

The present invention relates generally to a cutting tool for rotary drilling of a plate, and more particularly to an innovative structure type of a rotary cutting unit for a rotary saw.

### 2. Description of Related Art Including Information Disclosed Under 37 CFR 1.97 and 37 CFR 1.98

The rotary saw is a cutting tool for processing wood or metal plates to form circular holes in the plates. The known rotary saw comprises a main body, a scale rod, a center bit, two tool rests and two turning tools. The main body laterally penetrates a through hole, scale labels are formed on the surface of the scale rod, the scale rod axially penetrates the through hole, and the axis of the main body goes through the center of the scale rod. The main body is provided with a first bolt, the first bolt holds down the scale rod to position the main body. The shank of the center bit is inserted in the main body. The main body is provided with a second bolt. The second bolt holds down the shank to combine the shank with the main body. The tool rests are located on the scale rod respectively, the main body is located between the tool rests. The tool rests are provided for locating the turning tools. The tool rests can slide along the scale rod respectively to change the distance from the turning tools to the center bit.

To install different recessed lights, alarms, smoke detectors or other devices on a plate, the operator determines the radius of the circular hole to be processed according to the specification of the device to be installed. The tool rests are regulated to slide along the scale rod respectively, so that the distance from the turning tools to the axis of the center bit is exactly equal to the radius of the circular hole. At this point, the operator judges the distance from the turning tools to the axis of the center bit according to the graduations on the scale rod.

When shifting the tool rests according to the radius of the circular hole to be processed, the operator shall accurately move the tool rests to the corresponding graduations respectively, and then the tool rests are locked on the scale rod respectively. If the tool rests fail to be aligned with the corresponding graduations, the axis of the center bit deviates from the center point between the turning tools. In the operation of rotary drilling, the known rotary saw is likely to have deflection of center of gravity, influencing the shape, size and positioning of the processed circular hole, hazarding the safety of the operator.

When sliding the tool rests to align with the corresponding graduations, the environmental conditions, operator's vision and concentration will influence the accuracy of aligning the tool rests with the corresponding graduations, especially for the persons working on indoor woodwork fitment, the working environment is usually short of light, and the surface of different tools or cutting tools is often stained by fine wood dust or chips, leading to an adverse effect on identifying whether the tool rests are aligned with the corresponding graduations or not.

In addition, even if multiple circular holes processed by the known rotary saw in succession have the same aperture, if there are intervals between the hole machining operations, the operator shall recheck whether the tool rests have deviated from the corresponding graduations before use, the usability shall be enhanced.

There is another known rotary saw with single-tool rest, its construction is about the same as the aforementioned known rotary saw, the major difference is that the known single-tool rest rotary saw only has one tool rest between the center bit and one end of scale rod, the other end of scale rod is provided with a clump weight according to the position of the tool rest in the scale rod, so as to balance the weights of two ends of the scale rod. However, when regulating the positioning of the tool rest, the corresponding clump weight shall be changed, the usability of the known single-tool rest rotary saw shall also be improved.

### BRIEF SUMMARY OF THE INVENTION

The fundamental purpose of the present invention is to provide a rotary cutting unit for a rotary saw, the technical problem to be solved is to break through how to quickly and easily change the aperture processed.

Based on the aforementioned purpose, the technical characteristic of problem solving of the present invention is that the rotary cutting unit for a rotary saw comprises a cross bar and at least one cutting structure. Wherein the cross bar is a long rod, for combining the driver element of rotary saw. The cutting structure is in contact with the cross bar. The cutting structure is provided with a cutting edge. The cross bar penetrates a sleeve hole, so that the center bit of rotary saw axially penetrates the sleeve hole. The center of gravity of the rotary cutting unit is located in an axis through the center of the sleeve hole, and the axis is perpendicular to the major axis of the cross bar through two ends.

In terms of main effect and advantages of the present invention, to form a circular hole in a plate, a rotary cutting unit of the corresponding specification is selected according to the radius of the circular hole, the center bit of rotary saw axially penetrates through the sleeve hole, so that the driver element is combined with the rotary cutting unit, and the plate can be processed to form the circular hole, the aperture of the circular hole to be processed can be changed quickly and easily, the usability is high, and the aperture error value of the processed circular hole can be controlled effectively and accurately.

### BRIEF DESCRIPTION OF THE SEVERAL VIEWS OF THE DRAWINGS

FIG. 1 is a stereogram of Embodiment 1 of the present invention.

FIG. 2 is a three-dimensional exploded diagram of the rotary saw in Embodiment 1 of the present invention.

FIG. 3 is a stereogram of Embodiment 2 of the present invention.

FIG. 4 is a three-dimensional exploded diagram of the rotary saw in Embodiment 2 of the present invention.

FIG. 5 is a stereogram of Embodiment 3 of the present invention.

### DETAILED DESCRIPTION OF THE INVENTION

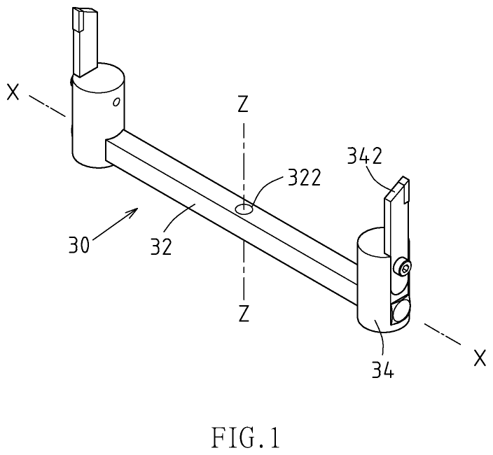

FIG. 1 shows the Embodiment 1 of the rotary cutting unit for a rotary saw of the present invention, but the embodiments are for illustration only, the patent application is not limited to this structure.

The aforementioned rotary cutting unit 30 comprises a cross bar 32 and two cutting structures 34, wherein the cross bar 32 is a long rod, the cross bar 32 perpendicularly penetrates a sleeve hole 322, the cutting structures 34 are connected to both ends of the cross bar 32 respectively, so that the sleeve hole 322 is formed between the cutting structures 34. The cutting structures 34 are provided with a cutting edge 342 respectively, a virtual axis Z-Z goes through the center of the sleeve hole 322, and the axis Z-Z is perpendicular to the major axis X-X of the cross bar 32 through both ends. The distances from the sleeve hole 322 to the cutting structures 34 are equal, so that the center of gravity of the rotary cutting unit 30 is located on the axis Z-Z.

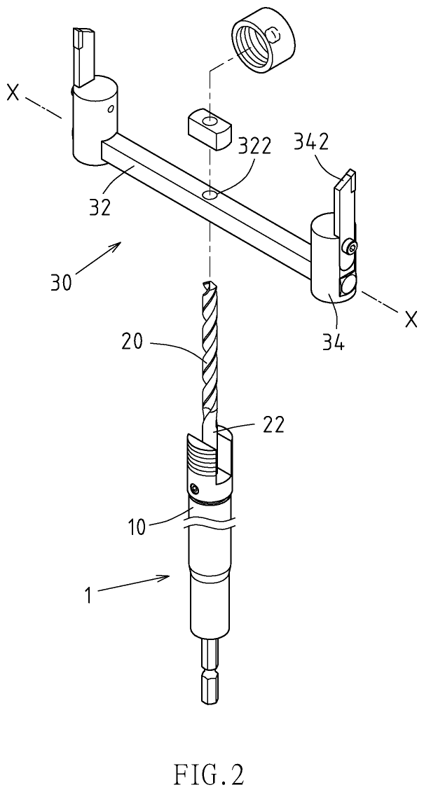

As shown in FIG. 2, the rotary saw in the aforementioned Embodiment 1 comprises a driver element 1, a center bit 20 and the rotary cutting unit 30. Wherein the driver element 1 is connected to a power tool (not shown in the picture), so that the driver element 1 is actuated by the power tool to rotate. The driver element 1 is provided with a main body 10, the drill shank 22 of the center bit 20 axially enters the main body 10, so that the center bit 20 is coupled with the main body 10. The center bit 20 of the main body 10 combined with the driver element 1 axially penetrates the sleeve hole 322, and the main body 10 is in contact with cross bar 32.

When the rotary saw of Embodiment 1 is used to process a plate to form a circular hole, according to the radius of the circular hole, a rotary cutting unit 30 with the corresponding distance between the sleeve hole 322 and the cutting structures 34 is selected, the center bit 20 axially penetrates the sleeve hole 322, and the main body 10 is in contact with the cross bar 32, so that the driver element 1 is combined with the rotary cutting unit 30, the power tool actuates the driver element 1, so as to process the plate the form the circular hole.

When processing another circular hole with a different aperture in the plate, the rotary cutting unit 30 can be separated from the driver element 1, another rotary cutting unit 30 with the distance between the sleeve hole 322 and the cutting structures 34 corresponding to the radius of the circular hole to be formed is combined with the driver element 1, so as to implement the processing operation of circular holes with different apertures.

The hole machining operator does not need to regulate the distance from the cutting structures 34 to the center bit 20 according to the aperture of the circular hole, but to fix a rotary cutting unit 30 of the corresponding specification to the driver element 1, to select the rotary cutting unit 30 of the corresponding specification and model from several rotary cutting units 30, the operator shall pay much less attention than to regulate the tool rest of the known rotary saw. Even if in an underlit working environment or the instrument surface is stained by different particles, the selection and installation of the corresponding rotary cutting unit 30 can be completed accurately and easily, the usability is high.

On the other hand, different measurers, molds and fixtures with high precision and availability and different processing equipments can be used in the production environment in good condition, according to the requirement for processing circular holes with different apertures, to manufacture the rotary cutting unit 30 of different specifications, the aperture error value of the processed circular hole available for the rotary cutting unit 30 can be controlled effectively and accurately, it is more reliable than the known rotary saw which requires the field operator to read graduations with naked eye and regulate the shift of rotary cutting unit.

The center of gravity of the rotary cutting unit 30 is located on the axis Z-Z through the center of the sleeve hole 322, there will be no center-of-gravity shift during the processing of circular hole. Therefore, the cutting structures 34 are not limited to connecting two ends of the cross bar 32, the cutting structures 34 can be located between the sleeve hole 322 and both ends of the cross bar 32.

The Embodiment 2 illustrates the application of the present invention to a single-tool rotary saw. Embodiment 2 is derived from Embodiment 1.

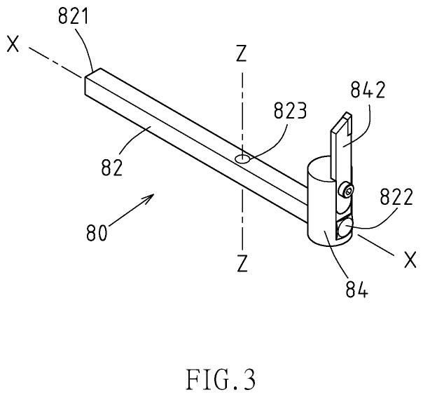

As shown in FIG. 3, the rotary cutting unit 80 for a rotary saw illustrated in the Embodiment 2 comprises a cross bar 82 and a cutting structure 84. Wherein the cross bar 82 is a long rod, the two ends of the major axis of the cross bar 82 are a first end 821 and a second end 822 respectively. The cross bar 82 perpendicularly penetrates a sleeve hole 823. The cutting structure 84 is in contact with the second end 822 of the cross bar 82. The cutting structure 84 is provided with a cutting edge 842. The sleeve hole 823 is formed between the first end 821 and the cutting structure 84, and the distance from the sleeve hole 823 to the first end 821 is larger than the distance from the sleeve hole 823 to the cutting structure 84. A virtual axis Z-Z goes through the center of the sleeve hole 823, and the axis Z-Z is perpendicular to the major axis X-X of the cross bar 82 through the first end 821 and the second end 822, so that the center of gravity of the rotary cutting unit 80 is located on the axis Z-Z.

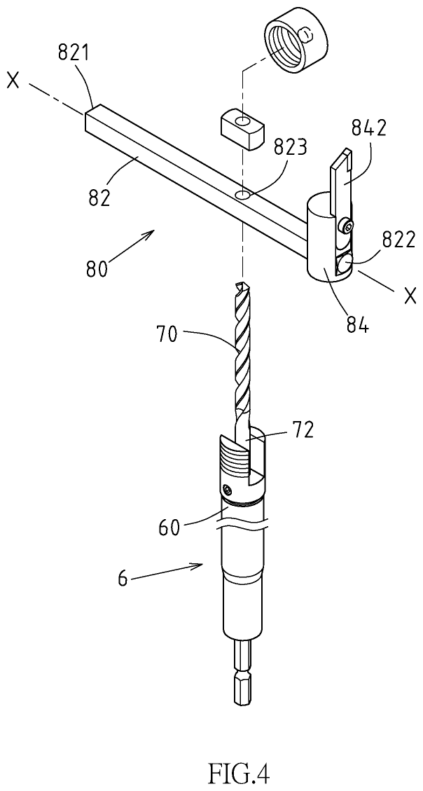

As shown in FIG. 4, the rotary saw in the Embodiment 2 comprises a driver element 6, a center bit 70 and the rotary cutting unit 80. Wherein the driver element 6 is connected to a power tool (not shown in the picture), so that the driver element 6 is actuated by the power tool to rotate. The driver element 6 is provided with a main body 60, the drill shank 72 of the center bit 70 axially enters the main body 60, so that the center bit 70 is coupled with the main body 60. The center bit 70 of the main body 60 combined with the driver element 6 axially penetrates the sleeve hole 823, and the main body 60 is in contact with cross bar 82.

The rotary cutting unit 80 uses the weight of the cross bar 82 between the sleeve hole 823 and the first end 821 to balance the weight of the cross bar 82 between the sleeve hole 823 and the second end 822 and the weight of the cutting structure 84, so that the center of gravity of the rotary cutting unit 80 is located on the axis Z-Z through the center of the sleeve hole 823.

In the Embodiment 2, the cutting structure 84 can be connected to the portion of the cross bar 82 between the second end 822 and the sleeve hole 823, so as to form a changed embodiment of Embodiment 2.

Another rotary saw not shown in the pictures can be formed from Embodiment 2, which comprises a driver element, a center bit and the rotary cutting unit 80. Wherein the driver element is connected to a power tool, so that the driver element is actuated by a power tool to rotate. The driver element has a main body, an insert hole is formed laterally in the main body, the intermediate section of the cross bar 82 is laterally embedded in the insert hole, the drill shank of the center bit is inserted in the main body and passing through the sleeve hole 823, so that the center bit is combined with the main body.

Embodiment 3 is derived from Embodiment 2, Embodiment 3 is identical to the construction of Embodiment 2, not to be described again.

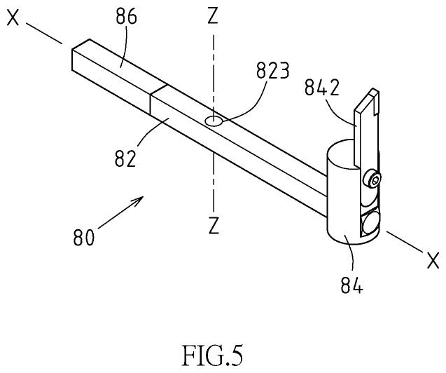

As shown in FIG. 5, the rotary cutting unit 80 for a rotary saw illustrated in Embodiment 3 comprises a cross bar 82, a cutting structure 84 and a clump weight 86. Wherein the cross bar 82 perpendicularly penetrates a sleeve hole 823. The clump weight 86 is in contact with the cross bar 82, so that the center of gravity of the rotary cutting unit 80 is located on an axis Z-Z through the center of the sleeve hole 823.

We claim:

1. A rotary cutting unit for a rotary saw comprises a cross bar and two cutting structures, wherein the cross bar is a long rod for combining the driver element of rotary saw, the cutting structures are in contact with the cross bar respectively; the cutting structures are provided with a cutting edge respectively; the cross bar penetrates a sleeve hole; the sleeve hole is formed between the cutting structures, and the distances from the sleeve hole to the cutting structures are identical, so that the center of gravity of the rotary cutting unit is located on an axis Z-Z through the center of the sleeve hole, and the axis Z-Z is perpendicular to the major axis X-X of the cross bar through two ends.

2. The rotary cutting unit for a rotary saw defined in claim 1, wherein the cutting structures are connected to both ends of the cross bar respectively.

3. A rotary cutting unit for a rotary saw comprises a cross bar and a cutting structure, wherein the cross bar is a long rod for combining the driver element of rotary saw, the two ends of major axis X-X of the cross bar are a first end and a second end respectively; the cross bar perpendicularly penetrates a sleeve hole, the cutting structure is in contact with the cross bar; the cutting structure is provided with a cutting edge, the sleeve hole is located between the cutting structure and the first end.

4. The rotary cutting unit for a rotary saw defined in claim 3, wherein the center of gravity of the rotary cutting unit is located on an axis Z-Z through the center of the sleeve hole, and the axis Z-Z is perpendicular to the major axis X-X of the cross bar through the first end and the second end.

5. The rotary cutting unit for a rotary saw defined in claim 3, wherein the distance from the sleeve hole to the first end is larger than the distance from the sleeve hole to the cutting structure.

6. The rotary cutting unit for a rotary saw defined in claim 4, wherein the distance from the sleeve hole to the first end is larger than the distance from the sleeve hole to the cutting structure.

7. The rotary cutting unit for a rotary saw defined in claim 5, wherein the rotary cutting unit comprises a clump weight, the clump weight is in contact with the cross bar, and the sleeve hole is formed between the cutting structure and the clump weight.

8. The rotary cutting unit for a rotary saw defined in claim 6, wherein the rotary cutting unit comprises a clump weight, the clump weight is in contact with the cross bar, and the sleeve hole is formed between the cutting structure and the clump weight.
